(19) United States
(12) Patent Application Publication
(10) Pub. No.: US 2002/0158433 A1
(43) Pub. Date: Oct. 31, 2002

(54) Child safety seatbelt

(76) Inventors: Philippe de Naurois, Germantown, MD (US); Regina Maria Figueiredo Carandina, Rio de Janeiro (BR)

Correspondence Address: Law Offices of Royal W. Craig, Suite 153, 10 North Calvert Street, Baltimore, MD, 21202, US

(21) Appl. No.: 10/116,679

(22) Filed: Apr. 4, 2002

Related U.S. Application Data
(60) Provisional application No. 60/281,329, filed on Apr. 4, 2001.

(51) Int. Cl. B62B 9/24

(52) U.S. Cl. 280/33.993

(57) ABSTRACT

A child safety seatbelt for restraining a child in a seat. The device comprises two independent straps each of which fasten at one end to the seat. The opposite ends of the straps lock together to form a continuous safety restraint over the waist of a child. An adjustment means is incorporated onto one of the straps to lengthen or shorten the seatbelt to ensure proper fit. The seatbelt further comprises textual or graphic indicia visible on the front face of the belt. The indicia may represent, for example, logos, instructions for use, or warnings. Accordingly the device may be used concurrently as a safety device and a marketing device for businesses, as for example when used on a shopping cart. Alternatively, the seatbelt may be used as a portable safety restraint device for private individual use.

### CROSS-REFERENCE TO RELATED APPLICATIONS

The present application derives priority from U.S. Provisional Patent Application No. 60/281,329 for “CHILD SAFETY SEATBELT”; filed: Apr. 4, 2001.

### BACKGROUND OF THE INVENTION

1. Field of the Invention

The present invention relates to child restraint devices. Specifically, it relates to a portable child safety seatbelt for restraining a child in a seat.

2. Description of the Background

To protect the safety of a child when riding in a child seat, stroller, baby chair, shopping cart seat or the like, it is appropriate to restrain the child around the waist using a seatbelt. Many seats intended for use by small children are not equipped with a means to safely secure the child.

Absent such restraining means, a child is liable to fall out of the seat and sustain an injury.

Such dangers are presented, for example, in a shopping cart child seat. Shopping carts commonly incorporate a collapsible compartment with an integral child seat. Typically, such seats comprise a backrest, a seat panel, and openings for the child's legs. Absent a restraining device, such seats fail to keep a child from standing, wriggling, or otherwise freeing himself from the confines of the seat. Once freed, the child may fall out of the seat and suffer serious injury.

Inventors have created several types of seatbelts for shopping carts. U.S. Pat. No. 4,550,800 to Dietrich discloses a shopping cart safety belt having a single strap coupled to an intermediate slide fastener and a terminal snap hook for attachment to a cart. The belt comprises a polypropylene webbing material.

U.S. Pat. No. 4,561,676 to Trubiano shows another child safety belt for shopping carts, comprising a single strap made of an elastic material.

U.S. Pat. No. 4,867,464 to Cook teaches a child restraining safety belt for a shopping cart seat. The device comprises a fabric material and secures a child using the combination of a waist-belt, a securing strap, and a pair of shoulder straps.

Unfortunately, each of these belts is made of a fabric material which is unhygienic and difficult to clean. The textured fibers of the fabric material trap and hold bacteria and germs. Proper cleaning of fabric materials soiled with such contaminants, dirt, or oily residues requires soaking and agitation in soapy water. Simply wiping the belts fails to remove the contaminants deeply embedded in the textured fibers of the fabric. Laundering such belts is complicated by the various clips and fasteners associated with the belts, which makes them unfit for washing in a conventional washing machine.

Further, it is difficult to incorporate printed material directly on fabric belts, as the additional manufacturing step of attaching a tag, stitching, or printing the written message onto the strap is required.

U.S. Pat. No. 5,378,046 to Gordy et al. discloses a portable shopping cart seat belt. The belt comprises an anchoring strap stitched to a primary waist belt strap. A snap hook carried on the anchoring strap secures the belt and child to a shopping cart. Unfortunately, the anchoring strap creates a weak point in the belt, and is susceptible to tearing when tension is placed on the belt during use.

U.S. Pat. No. 4,637,622 to Burgard shows an improved child safety strap for use in a shopping cart. The belt is permanently attached to the shopping cart using a grommet.

Unfortunately, although the grommet may help to preventing theft of the belt, it also unduly complicates the procedure for cleaning the belt, as the grommet must be removed in order to release the belt from the shopping cart.

Finally, U.S. Pat. No. 5,203,613 to Ward teaches a restraining device for use in a shopping cart, stroller, or chair. The device comprises a pair of straps having a releasable fastener at each end portion. However, the straps are of a nylon webbing material which presents the above-mentioned cleaning and printing hardships. Further, the straps attach to the frame of a shopping cart by crisscrossing over the back and chest of the child, and restrain the child by passing over his shoulders rather than around the waist. Consequently, the device is unduly cumbersome to use because it requires that the straps be connected at four separate points on the cart.

Lacking in the prior art, is a portable child safety seatbelt constructed in two pieces for easy attachment and removal to a child seat. Also lacking from the prior art is a two piece belt which, once attached to the seat, is secured around the waist of a child using a single central fastener. Lastly, absent from the prior art is a child safety seatbelt made from a material that is easily maintained in a sanitary, hygienic condition, and can be manufactured with aesthetically pleasing and highly visible raised indicia representing company logos, directions for use, warning instructions, or any textual or picto-graphic material.

In light of the foregoing, it would be of great advantage to create an improved child safety belt comprising independent strap portions which join together at a central fastener over the waist of a child. The two-piece construction enhances portability and convenience of operation. It would further be of great advantage to make the belt from a material which is easily maintained in a sanitary condition, and which bears integral raised indicia representing textual or graphic images.

### SUMMARY OF THE INVENTION

It is, therefore, an object of the present invention to restrain a child in a seat by providing a seatbelt for attachment to the seat and around the waist of a child.

It is another object of the present invention to construct the seatbelt in two distinct pieces each piece having a means for attaching to the seat on one end, and bearing corresponding interlocking elements of a central fastening means on the other end.

It is a further object to provide a seatbelt having an adjustment means to lengthen or shorten the belt to ensure a proper fit over the waist of a child.

It is yet another object to provide a seatbelt that is easily attached to and removed from a seat to promote portability and simplify use.

A still further object of the invention to provide a seatbelt comprising a vinyl plastisol material which facilitates the maintenance of the belt in a sanitary, hygienic condition by providing a material that is easily wiped clean of dirt, oils, and grime which naturally accumulate through use.

It is yet a further object of the present invention to provide a vinyl plastisol seatbelt having raised indicia representing company logos, directions for use, warning labels or any other textual or picto-graphic images integrally molded onto the seatbelt.

According to the present invention, the above-described and other objects are accomplished by providing a child safety seatbelt comprising a vinyl plastisol material. The seatbelt attaches to a child seat and is fastened around the waist of a child seated thereon. The seatbelt is equipped with terminal means to secure it to a child seat, and a central fastener to close the belt over the waist of a child. Raised indicia are present on the belt in the form of text or graphics, and an adjustable fastener is affixed to the belt for loosening or tightening to ensure a proper fit.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top view of the assembled child safety seatbelt.

FIG. 2 is a front view of the first strap of the child safety seatbelt.

FIG. 3 is rear view of the first strap of the child safety seatbelt.

FIG. 4 is front view of the second strap of the child safety seatbelt.

FIG. 5 is rear view of the second strap of the child safety seatbelt.

FIG. 6 is a perspective view of the child safety seatbelt in an exemplary fastened and operative configuration on a shopping cart.

### DETAILED DESCRIPTION OF THE PREFERRED EMBODIMENTS

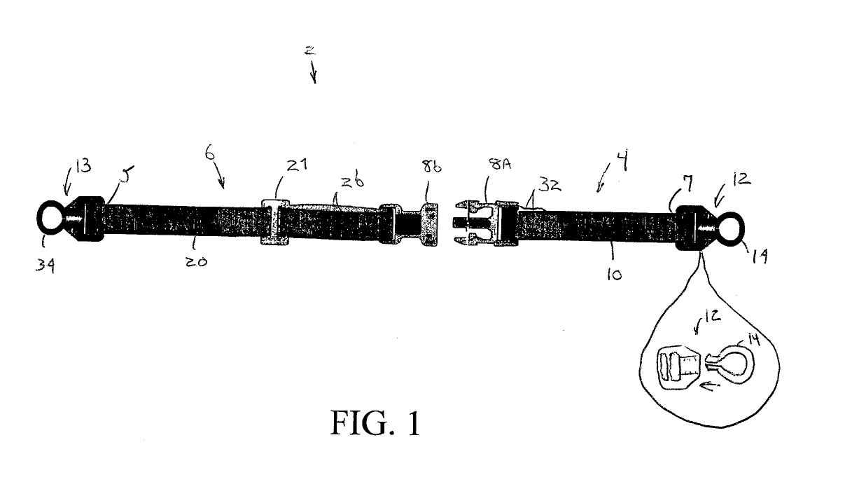

An improved child safety seatbelt 2 is shown in FIG. 1. The belt generally comprises a first strap portion 4 and a second strap portion 6. Strap portion 4 and strap portion 6 are individual separable elements of seatbelt 2 and may be releasably joined together by an interlocking fastener 8 to form a continuous child restraint device. Attachment mechanisms 12, 13 are carried on the ends of straps 4 and 6 respectively.

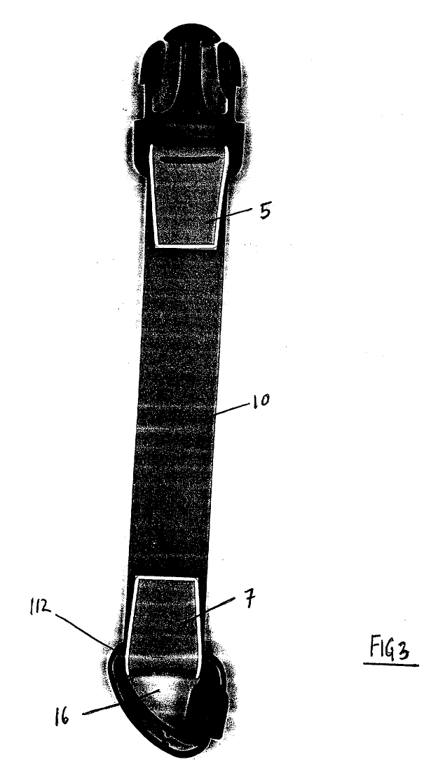

Band 10 engages attachment means 12, and end 5 engages male connector 8a of interlocking fastener 8. Attachment means 12 is preferably a two-piece pivoted ring, or “D” ring, comprising integral locking mechanism 14 which disengages to open the ring and locks together to securely close the ring. Attachment mechanism 12 preferably comprises plastic, but may alternatively comprise metal, rubber, vinyl plastisol or any other durable material. As shown in FIG. 3, end 7 engages attachment means 12 by passing through central opening 16, folding over attachment means 12, and attaching to the rear face of band 10. Band 10 thereby forms terminal loop 30 as shown in FIG. 1. End 7 may attach by stitching or gluing depending on the material composition of band 10.

First strap portion 4 comprises band 10 having a uniform width and thickness. Band 10 is of a molded vinyl plastisol construction. Vinyl plastisol is a vinyl homopolymer or copolymer suspension containing plasticizers and other additives. It is available in temperature-resistant formulations, exhibits excellent resistance to abrasion, sunlight, and many chemicals, has exceptional shock-absorbing characteristics, and comes in a wide range of colors and textures that appeal to the senses of sight and feel. Traditionally, vinyl plastisol has not been used in the manufacture of safety belts because of its flexibility and comparatively low tensile strength relative to woven vinyl or fabric straps. However, it is well suited for a child seat restraint where high tensile strength is less important (the purpose is restraint as opposed to impact protection), and the flexibility affords greater comfort.

Vinyl plastisol is a superior material for construction of seatbelt 2 because it is durable and easily manufactured by well known molding processes. Moreover vinyl plastisol is easily maintained in a sanitary condition because accumulated contaminants including bacteria, germs, dirt, oils and grime are easily wiped from its smooth surface with a damp cloth alone, or in conjunction with a conventional cleaning solvent. Alternatively, band 10 is a webbed material or other suitable fabric material.

FIG. 1 also shows the front face of second strap portion 6, which comprises band 20 having a uniform width and thickness equal to the dimensions of band 10, and made of the same material. Band 20 terminates at ends 5, and end 5 engages attachment mechanism 13 which includes a pivoted terminal loop 34 in the manner described above for terminal loop 14. Attachment means 13 is structurally and functionally identical in all respects to attachment means 12 described above.

Female connector 8b of interlocking fastener 8 is carried on the mid-portion of band 20. Female connector 8b comprises receptacle 9 for engaging male connector 8a, and slot 11. End 19 passes through slot 11 forming central loop configuration 26 (shown in FIG. 1). Central loop 26 thereby slidably secures female connector 8b to band 20.

Band 20 further carries adjustment means 22 which is preferably a slide fastener of the type well known in the prior art and within the public domain. Adjustment means 22 preferably comprises a rectangular fastener having a length slightly longer than the width of band 20 and a width of approximately one inch. Bar 24, centrally placed within adjustment means 22, extends through the length of the fastener from side to side.

Once through slot 11, end 19 reverses direction and continues along the rear face of band 20 toward attachment mechanism 13, and engages adjustment means 22. End 19 first passes under bar 24, then wraps over the top of bar 24 and continues in reverse direction toward female connector 8b, finally ending in terminal loop configuration 21 (as shown in FIG. 1).

Prior to engaging slot 11, end 19 is threaded under sides 22a and 22b of adjustment means 22, and over the top of bar 24 thereby forming a first engagement with adjustment means 22. Accordingly, terminal loop 21 comprises a second engagement between band 20 and adjustment means 22. Strap 6 is easily shortened or lengthened by threading band 20 over bar 24 from one side, and pulling from the other side to take up the slack.

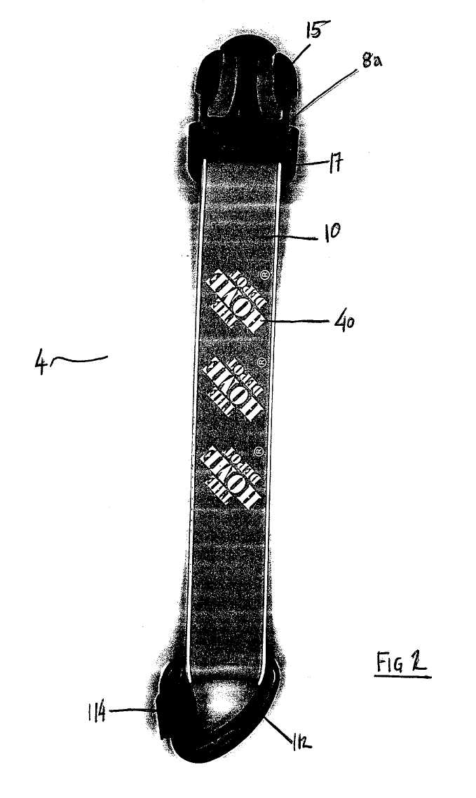

FIG. 2 is a front view of the first strap of the child safety seatbelt as in FIG. 1 except with an alternate one-piece attachment means 112. FIG. 3 is a back view of the first strap of FIG. 2.

As shown in FIG. 2, first strap portion 4 again comprises band 10 having a uniform width and thickness and terminating in ends 5, 7 (visible in FIG. 3). As before, band 10 is of a molded vinyl plastisol construction.

Referring again to FIG. 3, end 7 of band 10 engages attachment means 112, and end 5 engages male connector 8a of interlocking fastener 8. Attachment means 112 is preferably a one-piece ring, or “D” ring, comprising integral locking mechanism 114 which disengages to open the ring and locks together to securely close the ring. Attachment mechanism 112 preferably comprises plastic, but may alternatively comprise metal, rubber, vinyl plastisol or any other durable material. As shown in FIG. 3, end 7 engages attachment means 112 by passing through central opening 16, folding over attachment means 112, and attaching to the rear face of band 10. Band 10 thereby forms terminal loop 30 as shown in FIG. 1. End 7 may attach by stitching or gluing depending on the material composition of band 10.

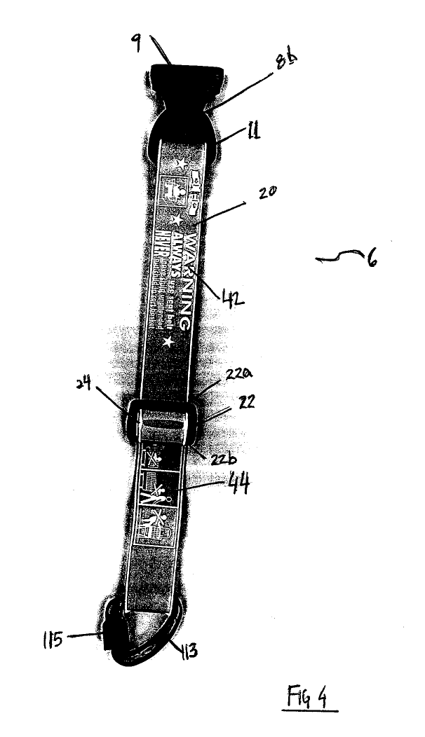

In the embodiments of FIGS. 1-3, male connector 8a of interlocking fastener 8 is carried on the opposite end of band 10. Male connector 8a comprises prong 15 for engaging receptacle 9 of female connector 8b (shown in FIG. 4), and slot 17. End 5 passes through slot 17, folds over male connector 8a, and attaches to the rear face of band 10. Band 10 thereby forms terminal loop 32 as shown in FIG. 1. Terminal loop 32 is constructed in the same fashion as terminal loop 30 described above.

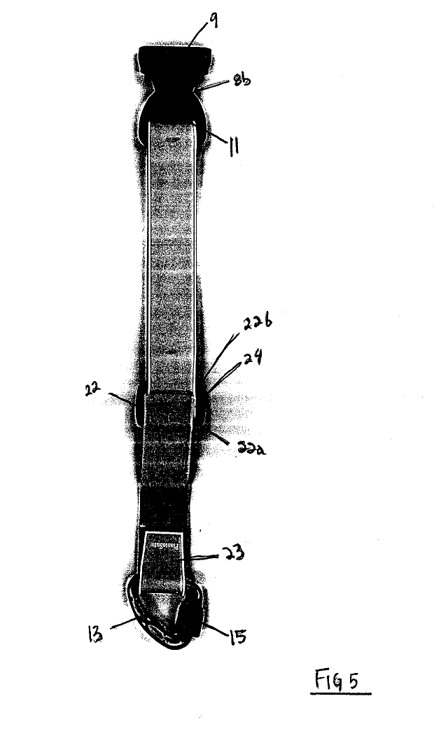

FIG. 4 shows the front face of second strap portion 6 with a one-piece ring, or “D” ring type attachment means as item 112 of FIG. 2. Second strap portion 6 comprises band 20 having a uniform width and thickness equal to the dimensions of band 10, and made of the same material. Band 20 terminates in ends 19, 23 shown in FIG. 4. As shown in FIG. 5, end 23 engages attachment mechanism 113 forming terminal loop 34 (visible in FIG. 1) in the manner described above for terminal loop 30. Attachment means 13 is structurally and functionally identical in all respects to attachment means 112 described above.

As described above with reference to FIG. 1, female connector 8b of interlocking fastener 8 is carried on the mid-portion of band 20 and comprises receptacle 9 for engaging male connector 8a, and slot 11. End 19 passes through slot 11 forming central loop configuration 26 (shown in FIG. 1). Central loop 26 thereby slidably secures female connector 8b to band 20.

Band 20 further carries adjustment means 22 which is preferably a slide fastener of the type well known in the prior art and within the public domain. Adjustment means 22 preferably comprises a rectangular fastener having a length slightly longer than the width of band 20 and a width of approximately one inch. Bar 24, centrally placed within adjustment means 22, extends through the length of the fastener from side to side.

Once through slot 11, end 19 reverses direction and continues along the rear face of band 20 toward attachment mechanism 13, and engages adjustment means 22. End 19 first passes under bar 24, then wraps over the top of bar 24 and continues in reverse direction toward female connector 8b, finally ending in terminal loop configuration 21 (as shown in FIG. 1). Prior to engaging slot 11, end 19 is threaded under sides 22a and 22b of adjustment means 22, and over the top of bar 24 thereby forming a first engagement with adjustment means 22. Accordingly, terminal loop 21 comprises a second engagement between band 20 and adjustment means 22. Strap 6 is easily shortened or lengthened by threading band 20 over bar 24 from one side, and pulling from the other side to take up the slack.

As best seen in FIGS. 2 and 4, indicia 40, 42, and 44 are present on the front face of bands 10, 20. Indica may comprise business logos 40, textual information such as warnings 42, or picto-graphic information 44 relating, for example, directions for use. Color schemes between bands 10, 20 and indicia 40, 42, 44 may be chosen to coincide with a particular business' logo or mark, or to provide contrast for improved legibility.

In all of the embodiments shown in FIGS. 1-4 wherein bands 10, 20 comprise molded vinyl plastisol, indicia 40, 42, 44 are integrally molded on the front face of the bands concurrently with the manufacture of bands 10, 20. In this manner, indicia 40, 42, 44 are easily and economically incorporated on seatbelt 2. Further, the integral raised indicia exhibit an improved resistance to wear over stitched or printed indicia, and are easily cleaned with the remainder of the belt. Alternatively, indicia 40, 42, 44 may be stitched or printed on bands 10, 20 in an embodiment wherein the bands are comprised of a fabric material.

### IN THE OPERATION

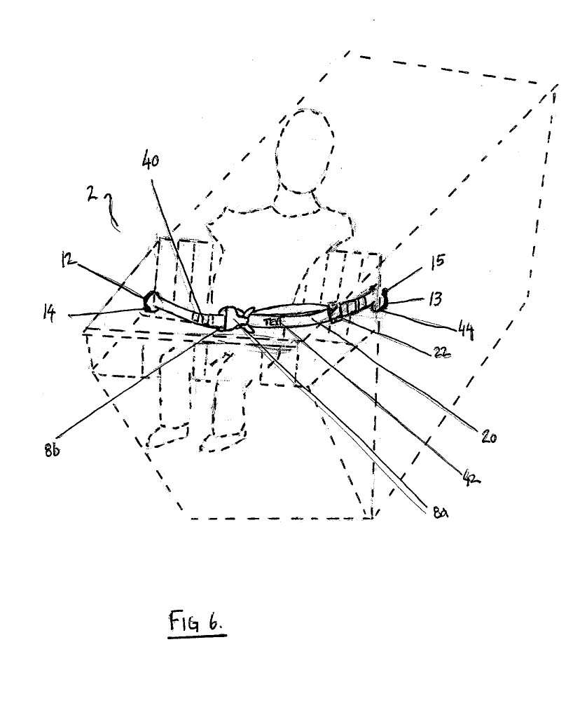

FIG. 6 is a perspective view of the seatbelt in an exemplary operative configuration on a shopping cart equipped with a child seat. Seatbelt 2 is secured to the cart by attachment means 12, 13. Locking mechanisms 14, 15 respectively are disengaged enabling attachment means 12, 13 to be secured around the frame of the cart. Engagement points should be selected on the cart on opposite sides of the child seated thereon, and at a height such that the belt crosses over the child at waist level. Once attachment means 12, 13 are in position, locking mechanisms 14, 15 are re-secured. Female connector 8b and male connector 8a are then fastened over the midsection of the child, and form the continuous restraint device. Band 20 may be shortened or lengthened using adjustment means 22 to ensure a proper fit. Thus assembled, indicia 40, 42, 44 are visible on the outer face of bands 10, 20.

The child is subsequently removed from the seat by disengaging interlocking fastener 8. The belt may be left in the cart if the property of the store, or may be disengaged from the frame of the cart in the reverse manner of assembly if the property of the individual user. Accordingly, the belt is portable for individual use, or may remain removably affixed to the cart for customer use. Moreover, visible indicia 40, 42, 44 render seatbelt 2 both a protective safety device, as well as a valuable marketing device.

The portable nature of the child safety belt as assembled and used as described herein enables a broad range of child seats to be retrofitted for improved safety. Accordingly, attachment means 12, 13 are secured to the frame of a stroller, high-chair, baby seat, car seat, or the like and the belt is fastened over the waist of a child as described above with reference to the exemplary shopping cart child seat.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims:

We claim:

1. A child restraining seatbelt comprising:
(a) a first strap of vinyl plastisol material;
(b) a second strap of vinyl plastisol material;
(c) an attachment means for removably securing one end each of said first strap and one end of said second strap to a child seat; and
(d) a fastening means for securing said first strap to said second strap;
whereby said first strap and said second strap are removably attached to said child seat by said attachment means, and said first strap and said second strap are fastened together by said fastening means across the waist of a child present on said child seat.

2. The child restraining seatbelt of claim 1, wherein said first strap comprises integral raised indicia molded on its front face.

3. The child restraining seatbelt of claim 1, wherein said second strap comprises integral raised indicia molded on its front face.

4. The child restraining seatbelt of claim 1, wherein said first strap comprises integral raised indicia molded on its front face, said indicia comprising textual or graphic representations of logos, directions for use, or warnings.

5. The child restraining seatbelt of claim 1, wherein said second strap comprises integral raised indicia molded on its front face, said indicia comprising textual or graphic representations of logos, directions for use, or warnings.

6. The child restraining seatbelt of claim 1, wherein said second strap comprises an adjustment means to adjustably lengthen or shorten said second strap.

7. A child restraining seatbelt for a shopping cart comprising:
(a) a first strap of vinyl plastisol material displaying integral raised indicia;
(b) a second strap of vinyl plastisol material displaying integral raised indicia; and
comprising an adjustment means to adjustably lengthen or shorten said second strap;
(c) an attachment means for removably securing one end each of said first strap and one end of said second strap to a shopping cart; and
(d) a fastening means for securing said first strap to said second strap;
whereby said first strap and said second strap are removably attached to said shopping cart using said attachment means, said first strap and said second strap are fastened together by said fastening means across the waist of a child present in the seat of said shopping cart, and said indicia are visibly present on the front face of said first strap and said second strap.

8. A child restraining seatbelt for a shopping cart comprising:
(a) a first strap displaying indicia;
(b) a second strap displaying indicia, and comprising an adjustment means to adjustably lengthen or shorten said second strap;
(c) an attachment means for removably securing one end each of said first strap and one end of said second strap to a shopping cart; and
(d) a fastening means for securing said first strap to said second strap,
whereby said first strap and said second strap are removably attached to said shopping cart using said attachment means, said first strap and said second strap are fastened together by said fastening means across the waist of a child present in the seat of said shopping cart, and said indicia are visibly present on the front face of said first strap and said second strap.
